(19) United States
(12) Patent Application Publication
(10) Pub. No.: US 2014/0140211 A1
(43) Pub. Date: May 22, 2014

(54) CLASSIFICATION OF TRAFFIC FOR APPLICATION AWARE POLICIES IN A WIRELESS NETWORK

(71) Applicant: CISCO TECHNOLOGY, INC., San Jose, CA (US)

(72) Inventors: Balachander Chandrasekaran, San Ramon, CA (US); Kasi Nalamalapu, Cupertino, CA (US); Seema Nayak, Cupertino, CA (US)

(73) Assignee: CISCO TECHNOLOGY, INC., San Jose, CA (US)

(21) Appl. No.: 13/679,923

(22) Filed: Nov. 16, 2012

(51) Int. Cl. H04W 28/02

(52) U.S. Cl. CPC H04W 28/0268
USPC 370/235

(57) ABSTRACT

In one embodiment, a method includes performing stateful application classification on packets received at a controller and transmitting classification information to an access point. The classification information includes flow information and stateless rules for applying policies. The access point is configured to use the classification information to perform stateless application classification and apply policies to packets received from a mobile device. An apparatus and logic are also disclosed herein.

### TECHNICAL FIELD

The present disclosure relates generally to wireless networks, and more particularly, to application classification and Quality of Service (QoS) in wireless networks.

### BACKGROUND

Network policies such as QoS policies are typically applied at either an access point or a controller in a wireless network. Each implementation has drawbacks for application aware policies. For example, since stateful application classification is based on multiple packets within a flow, classification at the access point results in throughput and roaming issues. Classification performed at the controller does not allow for prioritization of traffic from wireless clients across the wired network.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 is a flowchart illustrating an overview of a process for classification of traffic for application aware policies in a wireless network, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises performing stateful application classification on packets received at a controller and transmitting classification information to an access point. The classification information comprises flow information and stateless rules for applying policies. The access point is configured to use the classification information to perform stateless application classification and apply policies to packets received from a mobile device.

In another embodiment, an apparatus generally comprises a stateful classifier for performing stateful application classification at a controller, a classification database for storing classification information, and a processor for transmitting the classification information to an access point. The classification information comprises flow information and stateless rules for applying policies. The access point is configured to use the classification information to perform stateless application classification and apply policies to packets received from a mobile device.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

In order to provide end-to-end Quality of Service (QoS), policies should be applied to both upstream and downstream traffic. In wireless networks, this would involve applying policies at both a controller and an access point. Application classification is needed if the policies are application dependent. However, when a client roams between access points, it may interrupt classification performed at the access point, since classification of the application is based on multiple packets and with roaming, the first packet of the flow may arrive on one access point and the second on another access point.

The embodiments described herein separate application classification into stateful and stateless classification to provide end-to-end application aware policies for media traffic for roaming clients. As described in detail below, a controller performs the initial stateful classification. Once the application is identified, the controller sends classification information to an access point for use in stateless classification of traffic at the access point. If the client roams, the controller can send the stateless classification information to the new access point. The embodiments provide a highly scalable implementation for end-to-end QoS for rich media (interactive media, multimedia) applications for roaming clients.

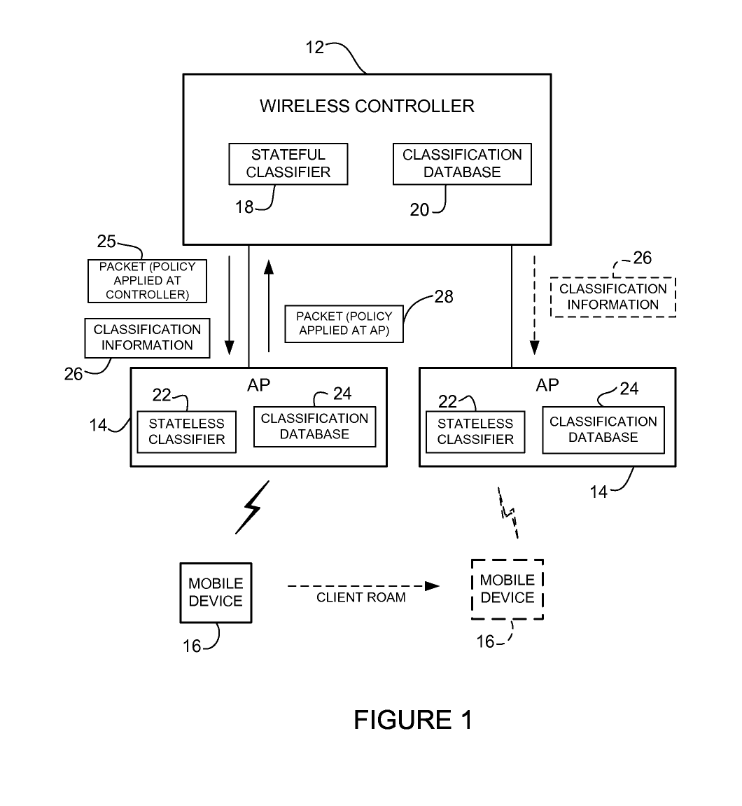

Referring now to the drawings, and first to FIG. 1, an example of a network in which embodiments described herein may be implemented is shown. For simplification, only a small number of network devices are shown. The network includes a wireless controller 12 in communication with a mobile device (client, wireless device, endpoint) 16 through an access point (AP) 14. In the example shown in FIG. 1, the controller 12 is in wired communication with two access points 14 for wireless communication with any number of mobile devices 16 via a wireless network (e.g., WLAN (wireless local area network)) at a network site. The wireless controller 12 may be in communication with one or more other networks (not shown) (e.g., Internet, intranet, local area network, wireless local area network, cellular network, metropolitan area network, wide area network, satellite network, radio access network, public switched network, virtual private network, or any other network or combination thereof). Communication paths between the wireless controller 12 and other networks or between the controller and access points 14 may include any number or type of intermediate nodes (e.g., routers, switches, gateways, or other network devices), which facilitate passage of data between network devices.

In one example, the wireless controller 12 receives upstream traffic transmitted from the mobile device 16 and destined for another endpoint (e.g., host, user device), and transmits downstream traffic received from the endpoint to the mobile device in a communication session. As used herein, the term ‘downstream’ refers to traffic transmitted from the controller 12 towards the mobile device 16, and the term ‘upstream’ refers to traffic transmitted from the mobile device towards the controller.

The term ‘wireless controller’ or ‘controller’ as used herein may refer to a wireless LAN (local area network) controller, mobility controller, wireless control device, wireless control system, or any other network device operable to perform control functions for a wireless network. The network site may also include a wireless control system or other platform for centralized wireless LAN planning, configuration, and management. The wireless controller 12 enables system wide functions for wireless applications and may support any number of access points 14. Each access point 14 may serve any number of mobile devices 16 in the wireless network. The wireless controller 12 may be, for example, a standalone device or a rack-mounted appliance. In the example shown in FIG. 1, the wireless controller 12 and access points 14 are separate devices and may be located remote from one another. The wireless controller 12 may also be integrated with the access point 14 (e.g., autonomous AP) or located at a switch, router, switch/router, or other network device. Thus, the wireless controller 12 may be a physical device located at a standalone device, access point, switch, router, or other network device. The wireless controller 12 may also be a virtual device located in a network or cloud, for example.

The mobile device 16 may be any suitable equipment that supports wireless communication, including for example, a mobile phone, personal digital assistant, portable computing device, laptop, tablet, multimedia device, or any other wireless device. The mobile device 16 and access point 14 are configured to perform wireless communication according to a wireless network communication protocol such as IEEE 802.11/Wi-Fi.

The wireless controller 12 includes a stateful application classifier 18 and the AP 14 includes a stateless application classifier 22. After the stateful classifier 18 identifies the application, the controller 12 transmits (e.g., pushes) classification information 26 to the AP 14 so that the AP can perform stateless classification and apply policies (e.g., QoS or other policies) to traffic received from the mobile device 16. The controller 12 may also provide the classification information 26 to another AP 14 if the client 16 roams to a new AP, as shown in FIG. 1. Implementation of the stateful classifier 18 at the controller 12 and stateless classifier 22 at the AP 14 allows for policies to be applied for downstream traffic (packet 25) at the wireless controller 12, and for upstream traffic (packet 28) at the access point 14.

The stateful classifier 18 at the controller 12 classifies traffic based on multiple packets received from the beginning of a flow. Stateful classification uses rules which need information on states for a previous packet (or packets) in a flow. Stateful classification may be based, for example, on packet pattern matching and decoding of protocols and their states. Stateful classification is also referred to as flow classification since it looks at a data stream of related packets (flow, session).

The stateless classifier 22 at the AP 14 uses rules that can act on a per packet basis in the flow. Stateless classification (also referred to as packet classification) is based on individual packet inspection (e.g., 5 tuple, pattern matching) without knowledge of any related stream of packets, flows, sessions, or protocols.

As noted above, stateful classification uses rules which need information on states for previous packets in a flow. When the client 16 roams (as shown in FIG. 1), the first packet of the flow may be received on one AP 14 and the second packet on another AP. Stateful classification is therefore performed at the controller 12 rather than the AP 14 so that stateful packet inspection is not broken when the client 16 roams. As described below, when the client 16 roams, the controller 12 pushes the same classification rules and policies that it previously sent to the original AP to the new AP.

In one embodiment, the stateful classifier 18 is a classification engine configured for NBAR (Network Based Application Recognition) or other technology used to classify applications. The classifier 18 is operable to recognize a wide variety of applications, including Web-based and client/server applications. The applications may include, for example, Skype, YouTube, Netflix, WebEx, Google Voice, BitTorrent, Citrix, virtual desktop, PCoIP, or any other application. The classification engine may be configured, for example, to identify generic protocols and perform heuristic analysis for encrypted protocols. The classifiers 18, 22 are configured to perform deep packet inspection (DPI), which provides the ability to look into the packet past basic header information so that the contents of a particular packet can be determined.

Once the application is recognized, QoS or other policies associated with the application can be applied to traffic so that the network can invoke services for that particular application. For example, the application may have certain requirements and expectations from the network infrastructure, which may be specified in terms of bandwidth, delay, jitter, throughput, packet loss, or other performance attributes.

The wireless controller 12 and AP 14 further include classification databases 20, 24, respectively, for storing classification information. The classification database 20 at the controller 12 stores classification information obtained by the stateful classifier 18. The classification database 24 at the AP 14 stores classification information 26 transmitted to the AP from the controller 12. The classification information stored at the databases 20, 24 may include, for example, flow information, stateless rules, and policies, as described below.

In one embodiment, the classification information 26 transmitted from the controller 12 to the AP 14 includes tuple information for a flow (e.g., source IP address, destination IP address, source port, destination port, and protocol), application identifier (ID), and stateless DPI information. Stateless DPI information includes classification and sub-classification information (e.g., fixed or variable offset with a pattern or regular expression) and rules for applying policies on the sub-classified packets. The policies may include, for example, drop packet, mark a DSCP (Differentiated Services Code Point) value in the packet, or rate limit the traffic.

It is to be understood that the network shown in FIG. 1 and described herein is only an example and that other networks having different components or configurations may be used, without departing from the scope of the embodiments. For example, there may be any number of APs 14 in communication with the controller 12 for supporting any number of mobile devices 16. Also, as described above, the controller 12 may be located at various locations and devices in the network.

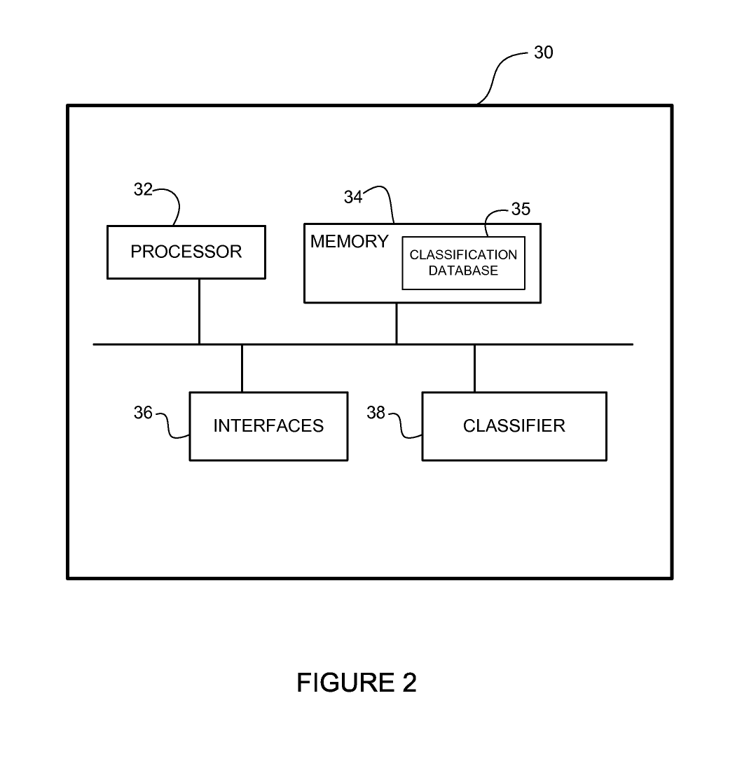

FIG. 2 illustrates an example of a network device 30 (e.g., wireless controller, AP) that may be used to implement the embodiments described herein. In one embodiment, the network device 30 is a programmable machine that may be implemented in hardware, software, or any combination thereof. The network device 30 includes one or more processor 32, memory 34, network interfaces 36, and classifier 38 (e.g., stateful classifier at controller or stateless classifier at AP).

Memory 34 may be a volatile memory or non-volatile storage, which stores various applications, operating systems, modules, and data for execution and use by the processor 32. Memory 34 may include, for example, classification database 35. The classification database 35 may be any data structure configured for at least temporarily storing classification information including, for example, flow information, application ID, stateless DPI rules, and policies.

Logic may be encoded in one or more tangible media for execution by the processor 32. For example, the processor 32 may execute codes stored in a computer-readable medium such as memory 34. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interfaces 36 may comprise any number of interfaces (linecards, ports) for receiving data or transmitting data to other devices. The network interface 36 may include, for example, an Ethernet interface for connection to a computer or network, or a wireless interface at AP 14.

The classifier 38 may comprise code, logic, a module, or a device. For example, the classifier 38 may comprise computer code stored in memory 34.

It is to be understood that the network device 30 shown in FIG. 2 and described above is only an example and that different configurations of network devices may be used. For example, the network device 30 may further include any suitable combination of hardware, software, algorithms, processors, devices, components, or elements operable to facilitate the capabilities described herein.

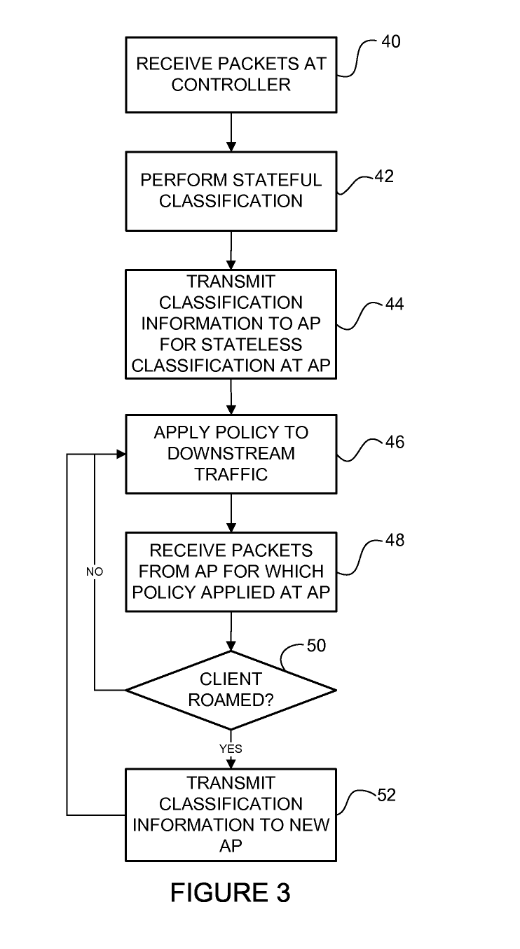

FIG. 3 is a flowchart illustrating an example of a process at the controller 12 for classification of traffic for application aware policies in a wireless network, in accordance with one embodiment. At step 40, the controller 12 receives packets belonging to a network flow. The controller 12 performs stateful classification to identify an application associated with the flow (step 42). The controller 12 transmits classification information (e.g., flow information, stateless DPI rule, and policy) to the AP 14 for use in stateless classification at the AP (step 44). The controller 12 applies policies to downstream traffic (received at the controller and destined for the client 16) (step 46) and receives upstream traffic for which policies have been applied at the AP 14 (step 48). If the controller 12 determines (e.g., receives an indication) that the client 16 has roamed, it transmits the classification information to the new AP 14 to which the client has roamed (steps 50 and 52).

It is to be understood that the process illustrated in FIG. 3 and described above is only an example and that steps may be modified, deleted, added, or combined without departing from the scope of the embodiments. For example, if traffic from the network destined for the mobile device 16 does not pass through the controller 12, policies are not applied by the controller for downstream traffic as shown in step 46. Also, if the policy applied at the AP 14 is to drop packets, those packets will not be received at the controller as shown in step 48.

The following describes an example of the above process for WebEx traffic that has different sub-classifications for voice and video traffic. Stateful classification is first performed by the controller 12 at the beginning of the flow. The controller 12 may need to process, for example, 10, 100, or any other number of packets to classify the flow as WebEx traffic. Once the classification is performed, the controller 12 sends the stateless DPI rules and flow information to the AP 14 for stateless sub-classification to distinguish voice, video, or data within a WebEx flow. For example, after the controller 12 identifies the WebEx meeting traffic, it pushes the tuple, the stateless DPI rules (as shown below), and policies to the AP 14 for upstream traffic marking, dropping, or rate-limiting. If the client 16 roams, the controller 12 transmits the same classification information to the new AP to which the client has roamed.

The following are examples of rules for WebEx video and WebEx voice after the traffic is identified as a WebEx meeting.

WebEx Video:
UDP Payload
First byte=0x06
Bytes [6-9]=Data length
10^{th} byte=0x50

WebEx Voice:
UDP Payload
First byte=0x06
Bytes [6-9]=Data length
10^{th} byte=0x48

The above rules are used to sub-classify the WebEx traffic as video or voice traffic using stateless classification. Based on the sub-classification, the AP 14 applies the appropriate policy to packets received from the mobile device 16.

It is to be understood that the WebEx classification described above is only an example and that the embodiments described herein may be applied to other applications as previously discussed.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
performing at a controller, stateful application classification on packets received at the controller; and
transmitting classification information to an access point, said classification information comprising flow information and stateless rules for applying policies;
wherein the access point is configured to use said classification information to perform stateless application classification and apply said policies to packets received from a mobile device.

2. The method of claim 1 wherein said stateless rules comprise deep packet inspection information.

3. The method of claim 1 wherein said stateful application classification identifies an application and said stateless application classification identifies a sub-classification of the application.

4. The method of claim 1 wherein said flow information comprises a source address, a destination address, a source port, a destination port, and a protocol.

5. The method of claim 1 wherein said classification information comprises an application identifier.

6. The method of claim 1 further comprising determining that the mobile device has roamed to a new access point and transmitting said classification information to the new access point.

7. The method of claim 1 further comprising applying said policies to packets received at the wireless controller and destined for the mobile device.

8. An apparatus comprising:
a stateful classifier for performing stateful application classification at a controller;
a classification database for storing classification information; and
a processor for transmitting said classification information to an access point, said classification information comprising flow information and stateless rules for applying policies;
wherein the access point is configured to use said classification information to perform stateless application classification and apply said policies to packets received from a mobile device.

9. The apparatus of claim 8 wherein said stateless rules comprise deep packet inspection information.

10. The apparatus of claim 8 wherein said stateful application classification identifies an application and said stateless application classification identifies a sub-classification of the application.

11. The apparatus of claim 8 wherein said flow information comprises a source address, a destination address, a source port, a destination port, and a protocol.

12. The apparatus of claim 8 wherein said classification information comprises an application identifier.

13. The apparatus of claim 8 wherein the processor is operable to receive an indication that the mobile device has roamed to a new access point and transmit said classification information to the new access point.

14. The apparatus of claim 8 wherein the processor is operable to apply said policies to packets received at the wireless controller and destined for the mobile device.

15. Logic encoded on one or more tangible computer readable media for execution and when executed operable to:
perform stateful application classification on packets received at a controller; and
transmit classification information to an access point, said classification information comprising flow information and stateless rules for applying policies;
wherein the access point is configured to use said classification information to perform stateless application classification and apply said policies to packets received from a mobile device.

16. The logic of claim 15 wherein said stateless rules comprise deep packet inspection information.

17. The logic of claim 15 wherein said stateful application classification identifies an application and said stateless application classification identifies a sub-classification of the application.

18. The logic of claim 15 wherein said flow information comprises a source address, a destination address, a source port, a destination port, and a protocol.

19. The logic of claim 15 further operable to determine that the mobile device has roamed to a new access point and transmit said classification information to the new access point.

20. The logic of claim 15 further operable to apply said policies to packets received at the wireless controller and destined for the mobile device.
